(19) United States
(12) Patent Application Publication
(10) Pub. No.: US 2026/0121568 A1
(43) Pub. Date: Apr. 30, 2026

(54) MOTOR DRIVER HAVING OVERCURRENT PROTECTION MECHANISM

(71) Applicant: ANPEC ELECTRONICS CORPORATION, HSINCHU (TW)

(72) Inventors: KUN-MIN CHEN, HSINCHU CITY (TW); Shih-Hai Chien, HSINCHU (TW)

(21) Appl. No.: 19/014,230

(22) Filed: Jan. 9, 2025

(30) Foreign Application Priority Data
Oct. 29, 2024 (TW) 113141176

(51) Int. Cl. H02P 29/024

(52) U.S. Cl. CPC H02P 29/027

(57) ABSTRACT

A motor driver having an overcurrent protection mechanism is provided. The motor driver includes an output stage circuit and a motor driving circuit. The output stage circuit includes a plurality of high-side switches, a plurality of low-side switches and a motor driving circuit. When an overcurrent event occurs in the output stage circuit according to a parameter of any one of the plurality of low-side switches, the motor driving circuit turns off all of the plurality of high-side switches. When all of the high-side switches are turned off and the overcurrent event is still occurring in the output stage circuit, the motor driving circuit turns off all of the plurality of low-side switches and continually turns off the high-side switches.

### CROSS-REFERENCE TO RELATED PATENT APPLICATION

This application claims the benefit of priority to Taiwan Patent Application No. 113141176, filed on Oct. 29, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor driver having an overcurrent protection mechanism.

### BACKGROUND OF THE DISCLOSURE

Circuit components of electronic products produce heat during operation, by which air circulated throughout an enclosed space, especially in an enclosed chassis of a server, is heated up. As a result, other circuit components can be damaged due to overheating. Therefore, fans must be disposed in the electronic products and used to cool down the circuit components of the electronic products.

However, conventional motor drivers are unable to effectively drive motors of the fans. When the conventional motor drivers drive the motors of the fans, reverse currents having large current values flow through the motors and switch components to an input power source, such that the conventional motor drivers and the input power sources are damaged. At this time, if a short circuit occurs in one or more of the switch components of the conventional motor drivers, the conventional motor drivers can be damaged even more seriously.

### SUMMARY OF THE DISCLOSURE

In response to the above-referenced technical inadequacies, the present disclosure provides a motor driver having an overcurrent protection mechanism. The motor driver includes an output stage circuit and a motor driving circuit. The output stage circuit includes a plurality of switch components. The plurality of switch components include a plurality of high-side switches and a plurality of low-side switches. Each of the plurality of high-side switches has a first terminal, a second terminal and a control terminal. The first terminal of each of the plurality of high-side switches is coupled to a common voltage. Each of the plurality of low-side switches has a first terminal, a second terminal and a control terminal. The first terminals of the plurality of low-side switches are respectively connected to the second terminals of the plurality of high-side switches, and respectively connected to a plurality of driving terminals or a motor. The motor driving circuit is connected to the control terminal of each of the plurality of high-side switches. The motor driving circuit is connected to the control terminal and the second terminal of each of the plurality of low-side switches. The motor driving circuit is configured to drive the plurality of high-side switches and the plurality of low-side switches. When the motor driving circuit senses the second terminal of any one of the plurality of low-side switches and accordingly determines that an overcurrent event occurs in the output stage circuit, the motor driving circuit turns off the plurality of high-side switches. When the plurality of high-side switches are turned off and the overcurrent event is still occurring in the output stage circuit, the motor driving circuit turns off the plurality of low-side switches and continually turns off the plurality of high-side switches.

In order to solve the above-mentioned problems, one of the technical aspects adopted by the present disclosure is to provide a motor driver having an overcurrent protection mechanism. The motor driver includes an output stage circuit and a motor driving circuit. The output stage circuit includes a plurality of switch components. The plurality of switch components include a plurality of high-side switches and a plurality of low-side switches. Each of the plurality of high-side switches has a first terminal, a second terminal and a control terminal. The first terminal of each of the plurality of high-side switches is coupled to a common voltage. Each of the plurality of low-side switches has a first terminal, a second terminal and a control terminal. The first terminals of the plurality of low-side switches are respectively connected to the second terminals of the plurality of high-side switches, and respectively connected to a plurality of driving terminals of a motor. The motor driving circuit is connected to the control terminal of each of the plurality of high-side switches, and is connected to the control terminal and the second terminal of each of the plurality of low-side switches. The motor driving circuit senses a voltage of the second terminal of each of the plurality of low-side switches, as a first sensed voltage. When the first sensed voltage is higher than a reference voltage, the motor driving circuit turns off the plurality of high-side switches and times a time during which the plurality of high-side switches are turned off as an off-time. When the off-time reaches a preset protection time, the motor driving circuit senses the second terminal of each of the plurality of low-side switches as a second sensed voltage. When the second sensed voltage is higher than the reference voltage, the motor driving circuit turns off the plurality of low-side switches and continually turns off the plurality of high-side switches.

As described above, the motor driver of the present disclosure provides the motor driver of the present disclosure. When the overcurrent event occurs in the output stage circuit of the motor driver of the present disclosure, all of the high-side switches of the motor driver of the present disclosure are instantly turned off such that a large current does not flow through the output stage circuit and the motor to the input power source. As a result, the plurality of high-side switches, the motor and the input power source of the motor driver of the present disclosure are prevented from being damaged.

In particular, when a short circuit occurs in the switch components of the motor driver of the present disclosure such that the large current flows through the motor driver of the present disclosure, all of the low-side switches are instantly turned off and all of the high-side switches are continually turned off in the motor driver of the present disclosure. As a result, the motor driver of the present disclosure is prevented from being seriously damaged.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver having an overcurrent protection mechanism according to a first embodiment of the present disclosure;

FIG. 2 is a circuit diagram of a single-phase motor and an output stage circuit of the motor driver having the overcurrent protection mechanism according to the first embodiment of the present disclosure;

FIG. 3 is a circuit diagram of a three-phase motor and an output stage circuit of the motor driver having the overcurrent protection mechanism according to the first embodiment of the present disclosure;

FIG. 4 is a flowchart diagram of steps of the motor driver having the overcurrent protection mechanism according to a second embodiment of the present disclosure;

FIG. 5 is a schematic diagram of switching states of an output stage circuit of a motor driver having an overcurrent protection mechanism applied on a single-phase motor and according to a third embodiment of the present disclosure; and

FIG. 6 is a schematic diagram of switching states of an output stage circuit of a motor driver having an overcurrent protection mechanism applied on a three-phase motor and according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

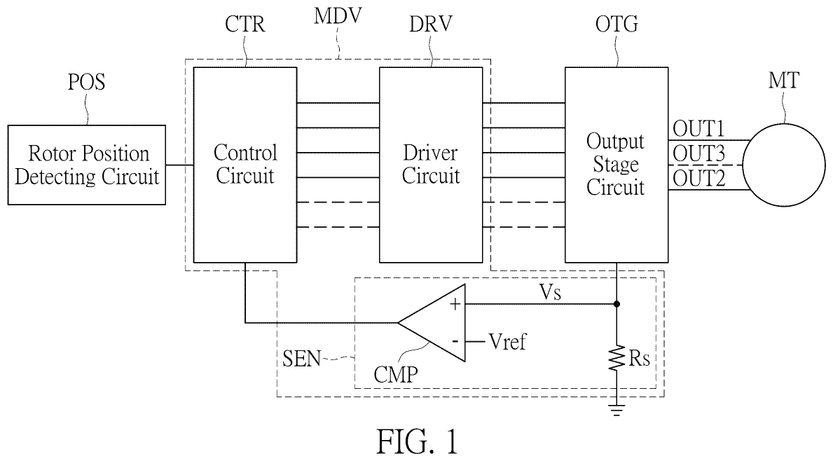

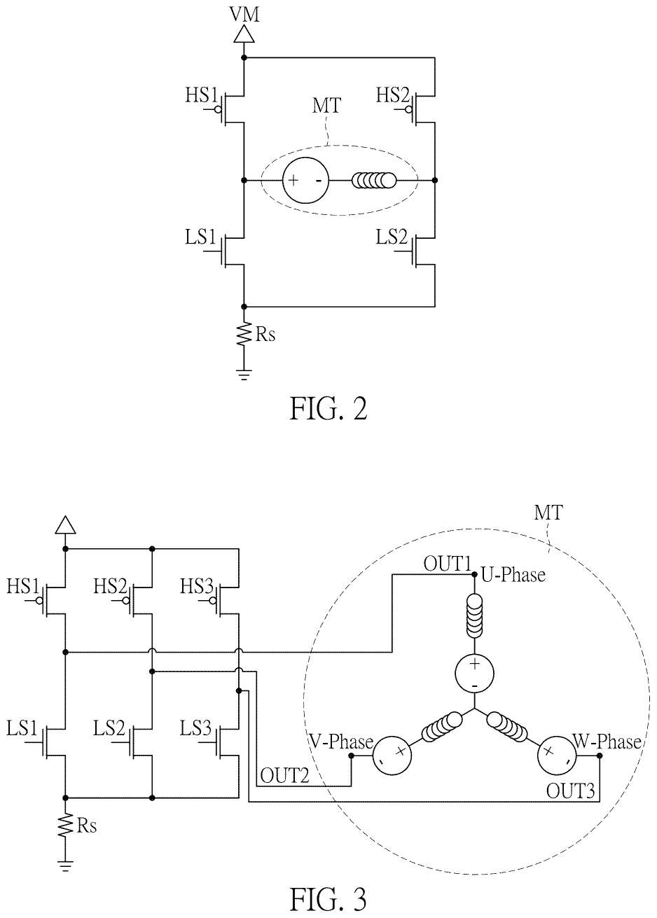

Reference is made to FIG. 1 to FIG. 3, in which FIG. 1 is a block diagram of a motor driver having an overcurrent protection mechanism according to a first embodiment of the present disclosure, FIG. 2 is a circuit diagram of a single-phase motor and an output stage circuit of the motor driver having the overcurrent protection mechanism according to the first embodiment of the present disclosure, and FIG. 3 is a circuit diagram of a three-phase motor and an output stage circuit of the motor driver having the overcurrent protection mechanism according to the first embodiment of the present disclosure.

The motor driver of the present disclosure includes a motor driving circuit MDV and an output stage circuit OTG as shown in FIG. 1. As shown in FIG. 1, the motor driving circuit MDV may include a control circuit CTR, a driver circuit DRV and a sensing circuit SEN. If necessary, the motor driving circuit MDV may further include a rotor position detecting circuit POS.

The output stage circuit OTG includes a plurality of switch components. The plurality of switch components includes a plurality of high-side switches and a plurality of low-side switches. Each of the plurality of switch components has a first terminal, a second terminal and a control terminal. The first terminals of the plurality of high-side switches are respectively connected to the second terminals of the plurality of high-side switches, and respectively connected to a plurality of driving terminals of a motor MT.

If the motor MT driven by the motor driver is a single-phase motor as shown in FIG. 1 and FIG. 2, the plurality of high-side switches of the output stage circuit OTG of the motor driver may include a first high-side switch HS1 and a second high-side switch HS2 as shown in FIG. 2, and the plurality of low-side switches of the output stage circuit OTG of the motor driver may include a first low-side switch LS1 and a second low-side switch LS2 as shown in FIG. 2.

If the motor MT driven by the motor driver is a three-phase motor as shown in FIG. 3, the plurality of high-side switches of the output stage circuit OTG of the motor driver may include the first high-side switch HS1, the second high-side switch HS2 and a third high-side switch HS3 as shown in FIG. 3, and the plurality of low-side switches of the output stage circuit OTG of the motor driver may include the first low-side switch LS1, the second low-side switch LS2 and a third low-side switch LS3 as shown in FIG. 3.

The first low-side switch LS1, the second low-side switch LS2 and the third low-side switch LS3 are any types of transistors, and the present disclosure is not limited thereto.

A first terminal of the first high-side switch HS1 is coupled to a common voltage VM. A second terminal of the first high-side switch HS1 is connected to a first terminal of the first low-side switch LS1. A second terminal of the first low-side switch LS1 is grounded. A node between the second terminal of the first high-side switch HS1 and the first terminal of the first low-side switch LS1 is connected to one of the plurality of driving terminals such as a first terminal OUT1 of the motor MT as shown in FIG. 1 to FIG. 3. The first terminal OUT1 of the motor MT may be a first terminal of a U-phase coil of the three-phase motor shown in FIG. 3.

A first terminal of the second high-side switch HS2 is coupled to the common voltage VM. A second terminal of the second high-side switch HS2 is connected to a first terminal of the second low-side switch LS2. A second terminal of the second low-side switch LS2 is grounded. A node between the second terminal of the second high-side switch HS2 and the first terminal of the second low-side switch LS2 is connected to another of the plurality of driving terminals such as a second terminal OUT2 of the motor MT as shown in FIG. 1 to FIG. 3. The second terminal OUT2 of the motor MT may be a first terminal of a V-phase coil of the three-phase motor shown in FIG. 3.

A first terminal of the third high-side switch HS3 is coupled to the common voltage VM. A second terminal of the third high-side switch HS3 is connected to a first terminal of the third low-side switch LS3. A second terminal of the third low-side switch LS3 is grounded. A node between the second terminal of the third high-side switch HS3 and the first terminal of the third low-side switch LS3 is connected to yet another of the plurality of driving terminals such as a third terminal OUT3 of the motor MT as shown in FIG. 1 to FIG. 3. The third terminal OUT3 of the motor MT may be a first terminal of a W-phase coil of the three-phase motor shown in FIG. 3.

The sensing circuit SEN may be connected to the second terminal of each or any one of the plurality of low-side switches (such as the first low-side switch LS1, the second low-side switch LS2 and the third low-side switch LS3). The sensing circuit SEN may sense one or more parameters of each or any one of the plurality of low-side switches. The parameters include voltages, currents or any combination thereof.

The control circuit CTR determines whether or not an overcurrent event occurs in the output stage circuit OTG to generate a determined result according to the parameters sensed by the sensing circuit SEN. The control circuit CTR sets and outputs a plurality of control signals according to the determined result.

For example, the control circuit CTR may determine whether or not the voltage of the second terminal of the low-side switch is higher than a reference voltage for determining whether or not the overcurrent event occurs in the output stage circuit OTG to output the plurality of control signals.

When the voltage of the second terminal of the low-side switch is higher than the reference voltage, the control circuit CTR determines that the overcurrent event occurs in the output stage circuit OTG. Conversely, when the voltage of the second terminal of the low-side switch is not higher than the reference voltage, the control circuit CTR determines that the overcurrent event does not occur in the output stage circuit OTG.

For example, the sensing circuit SEN may include a sensing resistor Rs, a comparator CMP or a combination thereof. A first terminal of the sensing resistor Rs may be connected to the second terminal of each or any one of the plurality of low-side switches (such as the first low-side switch LS1, the second low-side switch LS2 and the third low-side switch LS3). A second terminal of the sensing resistor Rs is grounded. A first input terminal such as a non-inverting input terminal of the comparator CMP is connected to a first terminal of the sensing resistor Rs. A second input terminal such as an inverting input terminal of the comparator CMP is coupled to a reference voltage Vref. An output terminal of the comparator CMP is connected to a first input terminal of the control circuit CTR.

The comparator CMP may compare a voltage Vs of the sensing resistor Rs with the reference voltage Vref to determine a level of a comparing signal and output the comparing signal. The control circuit CTR may, according to the level of the comparing signal from the comparator CMP, determine whether or not the overcurrent event occurs in the output stage circuit OTG to output the plurality of control signals.

When the voltage Vs of the sensing resistor Rs is higher than the reference voltage Vref, the comparator CMP outputs the comparing signal having a first level such as a high level. The control circuit CTR determines that the overcurrent event occurs in the output stage circuit OTG according to the comparing signal at the first level such as the high level.

Conversely, when the voltage Vs of the sensing resistor Rs is lower than the reference voltage Vref, the comparator CMP outputs the comparing signal having a second level such as a low level. The control circuit CTR determines that the overcurrent event does not occur in the output stage circuit OTG according to the comparing signal at the second level such as the low level.

The rotor position detecting circuit POS may be connected to the control circuit CTR. The rotor position detecting circuit POS may detect a position of a rotor to output a rotor position detected signal. The control circuit CTR may adjust or set the plurality of control signals according to the rotor position detected signal from the rotor position detecting circuit POS.

The driver circuit DRV is connected to the control circuit CTR, the control terminal of each of the plurality of high-side switches of the output stage circuit OTG, and the control terminal of each of the plurality of low-side switches of the output stage circuit OTG. The driver circuit DRV may, according to the plurality of control signals from the control circuit CTR, output a plurality of driving signals respectively to control terminals of the plurality of switch components for driving the plurality of switch components.

It is worth noting that, when the control circuit CTR determines that the overcurrent event occurs in the output stage circuit OTG, the control circuit CTR controls the driver circuit DRV to turn off all of the plurality of high-side switches included in the output stage circuit OTG. For example, the control circuit CTR turns off the first high-side switch HS1 and the second high-side switch HS2, or turns off the first high-side switch HS1, the second high-side switch HS2 and the third high-side switch HS3. As a result, an excessive current is prevented from flowing through the motor MT and the high-side switches of the output stage circuit OTG to an input power source supplying the common voltage VM. Therefore, the input power source, the motor MT and the output stage circuit OTG are prevented from being damaged by the excessive current.

It is worth noting that, if a short circuit occurs in the high-side switch being turned off in the output stage circuit OTG, a large current flows from the input power source through the high-side switch in which the short circuit occurs to the switch component of the output stage circuit OTG and the motor MT. Under this condition, the control circuit CTR continually turns off all of the plurality of high-side switches included in the output stage circuit OTG. In addition, the control circuit CTR turns off all of the plurality of low-side switches (such as the first low-side switch LS1 and the second low-side switch LS2 as shown in FIG. 2 or the first low-side switch LS1, the second low-side switch LS2 and the third low-side switch LS3 as shown in FIG. 3). As a result, a large area of the conventional motor drivers is prevented from being damaged.

More specifically, the sensing circuit SEN may sense the parameters of the second terminal of any one of the plurality of low-side switches (such as the first low-side switch LS1, the second low-side switch LS2 and the third low-side switch LS3). When the control circuit CTR determines that the overcurrent event occurs in the output stage circuit OTG according to the parameters sensed by the sensing circuit SEN, the control circuit CTR controls the driver circuit DRV to turn off all of the plurality of high-side switches included in the output stage circuit OTG. As a result, the input power source, the motor MT and the output stage circuit OTG are prevented from being damaged due to overcurrent.

After the control circuit CTR controls the driver circuit DRV to turn off all of the plurality of high-side switches included in the output stage circuit OTG, the sensing circuit SEN senses the parameters of the second terminal of each or any one of the plurality of low-side switches (such as the first low-side switch LS1, the second low-side switch LS2 and the third low-side switch LS3) again. The sensing resistor Rs determines whether or not the parameters that are currently sensed by the sensing circuit SEN is larger than a parameter threshold to determine whether or not the overcurrent event is still occurring in the output stage circuit OTG after all of the plurality of high-side switches are turned off.

When any of the parameters (such as the voltages and the current) that are currently sensed by the sensing circuit SEN is larger than the parameter threshold (such as a voltage threshold or a current threshold), the control circuit CTR determines that the overcurrent event occurs in the output stage circuit OTG.

Conversely, when each of the parameters (such as the voltages and the current) that are currently sensed by the sensing circuit SEN is not larger than the parameter threshold (such as the voltage threshold or the current threshold), the control circuit CTR determines that the overcurrent event does not occur in the output stage circuit OTG. At this time, the control circuit CTR may control the driver circuit DRV to normally switch the plurality of switch components included in the output stage circuit OTG for driving the motor MT to rotate normally.

When the control circuit CTR determines that the plurality of high-side switches included in the output stage circuit OTG are turned off but the overcurrent event is still occurring in the output stage circuit OTG, the control circuit CTR further turns off all of the plurality of low-side switches of the output stage circuit OTG, and continually turns off all of the plurality of high-side switches of the output stage circuit OTG. That is, at this time, the control circuit CTR controls the driver circuit DRV to turn off all of the plurality of switch components included in the output stage circuit OTG. At this time, the motor driver of the present disclosure stops driving the motor MT. As a result, a damaged area of the motor driver and the number of the circuit components that are damaged in the motor driver are prevented from being increased.

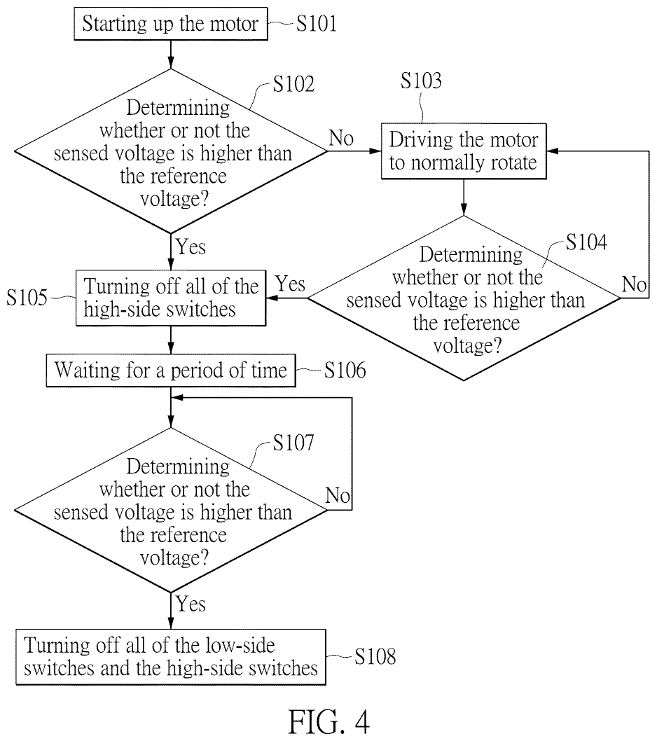

Reference is made to FIG. 4, which is a flowchart diagram of steps of the motor driver having the overcurrent protection mechanism according to a second embodiment of the present disclosure.

The motor driver of the present disclosure as shown in FIG. 1 is applicable to perform processes S101 to S108 shown in FIG. 4.

In process S101, the control circuit CTR controls the driver circuit DRV to drive the output stage circuit OTG to start up the motor MT.

In process S102, the sensing circuit SEN senses the voltage of the second terminal of any one of the plurality of low-side switches (such as the first low-side switch LS1, the second low-side switch LS2 and the third low-side switch LS3), as a first sensed voltage. The control circuit CTR determines whether or not the first sensed voltage is higher than the reference voltage Vref.

If the first sensed voltage is not higher than the reference voltage Vref, the control circuit CTR determines that the overcurrent event does not occur in the output stage circuit OTG, process S103 is performed. In process S103, the control circuit CTR controls the driver circuit DRV to normally switch the output stage circuit OTG for driving the motor MT to rotate normally.

When the motor MT rotates normally in process S103, the sensing circuit SEN may sense the voltage of the second terminal of any one of the plurality of low-side switches (such as the first low-side switch LS1, the second low-side switch LS2 and the third low-side switch LS3) again, as the first sensed voltage. The control circuit CTR determines whether or not the first sensed voltage is higher than the reference voltage Vref.

It is worth noting that, if the first sensed voltage is higher than the reference voltage Vref in step S102 or S104, the control circuit CTR determines that the overcurrent event occurs in the output stage circuit OTG and then process S105 is performed.

In process S105, the control circuit CTR controls the driver circuit DRV to turn off all of the plurality of high-side switches (such as the first high-side switch HS1 and the second high-side switch HS2 as shown in FIG. 2 or the first high-side switch HS1, the second high-side switch HS2 and the third high-side switch HS3 as shown in FIG. 3) in the output stage circuit OTG at the same time.

In process S106, the control circuit CTR times a time during which all of the plurality of low-side switches are turned off, as an off-time. When the off-time reaches a preset protection time, the sensing circuit SEN senses the voltage of the second terminal of any one of the plurality of low-side switches again as a second sensed voltage.

In process S107, the control circuit CTR determines whether or not the second sensed voltage is higher than the reference voltage Vref.

It is worth noting that, when the second sensed voltage is higher than the reference voltage Vref, the control circuit CTR determines that the overcurrent event is still occurring in the output stage circuit OTG. Under this condition, the control circuit CTR continually turns off all of the plurality of high-side switches included in the output stage circuit OTG as in process S105, and further turns off all of the plurality of low-side switches (such as the first low-side switch LS1 and the second low-side switch LS2 as shown in FIG. 2 or the first low-side switch LS1, the second low-side switch LS2 and the third low-side switch LS3 as shown in FIG. 3) in process S108.

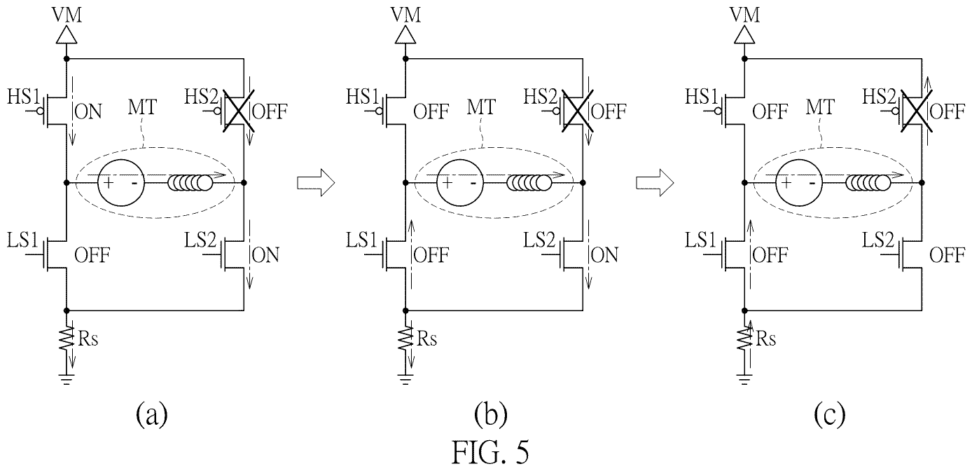

Reference is made to FIG. 5, which is a schematic diagram of switching states of an output stage circuit of a motor driver having an overcurrent protection mechanism applied on a single-phase motor and according to a third embodiment of the present disclosure.

The driver circuit DRV shown in FIG. 1 turns on the first high-side switch HS1 and the second low-side switch LS2 and turns off the second high-side switch HS2 and the first low-side switch LS1 as shown in a part (a) of FIG. 5.

The short circuit occurs in the second high-side switch HS2. As a result, one current flows from the input power source supplying the common voltage VM sequentially through the second high-side switch HS2 and the second low-side switch LS2 to the sensing resistor Rs as shown in the part (a) of FIG. 5. The other current flows sequentially through the first high-side switch HS1, the motor MT and the second low-side switch LS2 to the sensing resistor Rs. The control circuit CTR may obtain the voltage of the first terminal of the sensing resistor Rs as the first sensed voltage.

When the control circuit CTR determines that the first sensed voltage is higher than the reference voltage Vref, the control circuit CTR controls the driver circuit DRV to turn off both of the first high-side switch HS1 and the second high-side switch HS2 as shown in a part (b) of FIG. 5.

The control circuit CTR times a time during which the first high-side switch HS1 and the second high-side switch HS2 are turned off. When the time during which the first high-side switch HS1 and the second high-side switch HS2 are turned off reaches the preset protection time, the control circuit CTR obtains the voltage of the first terminal of the sensing resistor Rs as the second sensed voltage.

When control circuit CTR determines that the second sensed voltage is higher than the reference voltage Vref, the control circuit CTR controls the driver circuit DRV to continually turn off the first high-side switch HS1, the second high-side switch HS2, and to further turn off the first low-side switch LS1 and the second low-side switch LS2 as in a part (c) of FIG. 5.

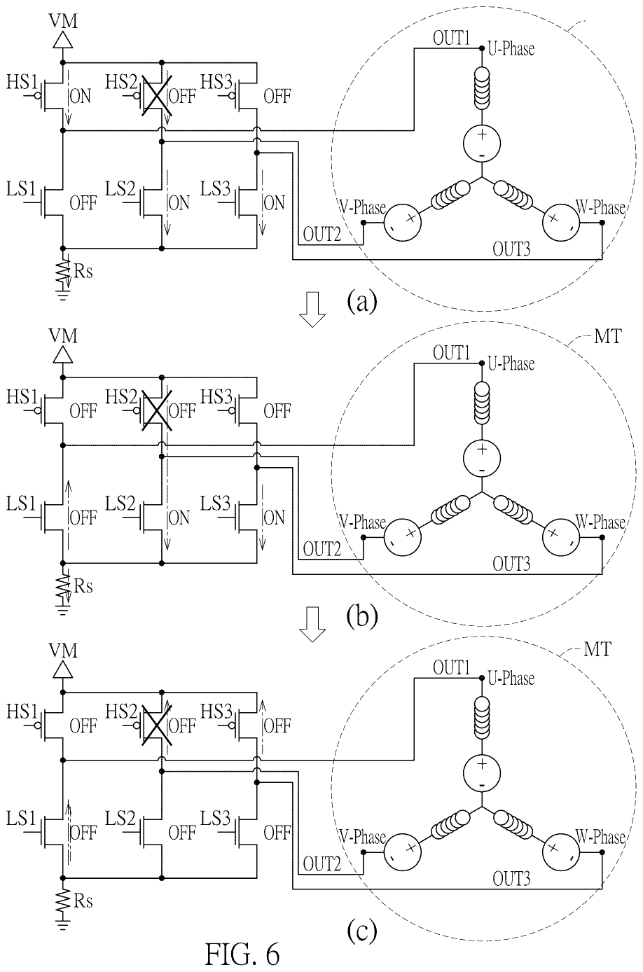

Reference is made to FIG. 6, which is a schematic diagram of switching states of an output stage circuit of a motor driver having an overcurrent protection mechanism applied on a three-phase motor and according to a fourth embodiment of the present disclosure.

The driver circuit DRV may turn on the first high-side switch HS1, the second low-side switch LS2 and the third low-side switch LS3, and turn off the first low-side switch LS1, the second high-side switch HS2 and the third high-side switch HS3 as in the part (a) of FIG. 5. When a short circuit occurs in the second high-side switch HS2, a current flows from the input power source supplying the common voltage VM to the second high-side switch HS2 as in a part (a) of FIG. 6, the control circuit CTR obtains the voltage of the first terminal of the sensing resistor Rs as the first sensed voltage.

When the control circuit CTR determines that the first sensed voltage is higher than the reference voltage Vref, the control circuit CTR controls the driver circuit DRV to turn off the first high-side switch HS1, the second high-side switch HS2 and the third high-side switch HS3 as shown in a part (b) of FIG. 6.

The control circuit CTR times the time during which first high-side switch HS1 and the second high-side switch HS2 are turned off. When the time during which first high-side switch HS1 and the second high-side switch HS2 are turned off reaches the preset protection time, the control circuit CTR obtains the voltage of the first terminal of the sensing resistor Rs as the second sensed voltage.

When the control circuit CTR determines that the second sensed voltage is higher than the reference voltage Vref, the control circuit CTR controls the driver circuit DRV to turn off the first high-side switch HS1, the second high-side switch HS2, the third high-side switch HS3, the first low-side switch LS1, the second low-side switch LS2 and the third low-side switch LS3, as shown in a part (c) of FIG. 6.

In conclusion, the motor driver of the present disclosure provides the motor driver of the present disclosure. When the overcurrent event occurs in the output stage circuit of the motor driver of the present disclosure, all of the high-side switches of the motor driver of the present disclosure are instantly turned off such that the large current does not flow through the output stage circuit and the motor to the input power source. As a result, the plurality of high-side switches, the motor and the input power source of the motor driver of the present disclosure are prevented from being damaged.

In particular, when a short circuit occurs in the switch components of the motor driver of the present disclosure such that the large current flows through the motor driver of the present disclosure, all of the low-side switches are instantly turned off and all of the high-side switches are continually turned off in the motor driver of the present disclosure. As a result, the motor driver of the present disclosure is prevented from being seriously damaged.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver having an overcurrent protection mechanism, comprising:
an output stage circuit including a plurality of switch components, wherein the plurality of switch components include:
a plurality of high-side switches each having a first terminal, a second terminal and a control terminal, wherein the first terminal of each of the plurality of high-side switches is coupled to a common voltage; and
a plurality of low-side switches each having a first terminal, a second terminal and a control terminal, wherein the first terminals of the plurality of low-side switches are respectively connected to the second terminals of the plurality of high-side switches and respectively connected to a plurality of driving terminals or a motor; and
a motor driving circuit connected to the control terminal of each of the plurality of high-side switches, connected to the control terminal and the second terminal of each of the plurality of low-side switches, and configured to drive the plurality of high-side switches and the plurality of low-side switches;
wherein, when the motor driving circuit senses the second terminal of any one of the plurality of low-side switches and accordingly determines that an overcurrent event occurs in the output stage circuit, the motor driving circuit turns off the plurality of high-side switches;
wherein, when the plurality of high-side switches are turned off and the overcurrent event is still occurring in the output stage circuit, the motor driving circuit turns off the plurality of low-side switches and continually turns off the plurality of high-side switches.

2. The motor driver according to claim 1, wherein the motor driving circuit senses a parameter of the one of the plurality of low-side switches, and the parameter includes a voltage, a current or a combination thereof.

3. The motor driver according to claim 1, wherein, when a time during which the plurality of high-side switches are turned off reaches a preset protection time, the motor driving circuit determines whether the overcurrent event is still occurring in the output stage circuit.

4. The motor driver according to claim 3, wherein, when the time during which the plurality of high-side switches are turned off reaches the preset protection time and the overcurrent event is still occurring in the output stage circuit, the motor driving circuit turns off the plurality of low-side switches.

5. The motor driver according to claim 1, wherein, when a voltage of the second terminal of any one of the plurality of low-side switches is higher than a reference voltage, the motor driving circuit determines that the overcurrent event occurs in the output stage circuit.

6. The motor driver according to claim 1, wherein the motor driving circuit includes:
a sensing circuit connected to the second terminal of each of the plurality of low-side switches, and configured to sense a voltage of the second terminal of the one of the plurality of low-side switches;
a control circuit connected to the sensing circuit, wherein the control circuit is configured to determine whether the voltage of the second terminal of the one of the plurality of low-side switches is higher than a reference voltage, and accordingly determine whether the overcurrent event occurs in the output stage circuit to output a plurality of control signals; and
a driver circuit connected to the control terminal of each of the plurality of high-side switches, the control terminal of each of the plurality of low-side switches and the control circuit, wherein the driver circuit is configured to output a plurality of driving signals respectively to the control terminals of the plurality of high-side switches and the plurality of low-side switches according to the plurality of control signals.

7. The motor driver according to claim 6, wherein the sensing circuit includes:
a sensing resistor, wherein a first terminal of the sensing resistor is connected to the second terminal of each of the plurality of switch components and the control circuit, and a second terminal of the sensing resistor is grounded;
wherein the control circuit is configured to determine whether or not the overcurrent event occurs in the output stage circuit according to a voltage of the sensing resistor, a current of the sensing resistor or a combination thereof.

8. The motor driver according to claim 7, wherein the sensing circuit further includes:
a comparator, wherein a first input terminal of the comparator is connected to the first terminal of the sensing resistor, a second input terminal of the comparator is coupled to a reference voltage, and an output terminal of the comparator is connected to the control circuit;
wherein the control circuit is configured to determine whether the overcurrent event occurs in the output stage circuit according to a comparing signal from the comparator.

9. The motor driver according to claim 1, further comprising:
a rotor position detecting circuit connected to the motor driving circuit and the motor, wherein the rotor position detecting circuit is configured to detect a position of a rotor of the motor to output a rotor position detected signal, and the motor driving circuit is configured to drive the motor according to the rotor position detected signal.

10. The motor driver according to claim 1, wherein the motor is a single-phase motor.

11. The motor driver according to claim 10, wherein the plurality of high-side switches includes a first high-side switch and a second high-side switch, and the plurality of low-side switches includes a first low-side switch and a second low-side switch;
wherein a first terminal of the first high-side switch is coupled to the common voltage, a second terminal of the first high-side switch is connected to a first terminal of the first low-side switch, a second terminal of the first low-side switch is grounded, and a node between the second terminal of the first high-side switch and the first terminal of the first low-side switch is connected to one of the plurality of driving terminals of the motor;
wherein a first terminal of the second high-side switch is coupled to the common voltage, a second terminal of the second high-side switch is connected to a first terminal of the second low-side switch, a second terminal of the second low-side switch is grounded, and a node between the second terminal of the second high-side switch and the first terminal of the second low-side switch is connected to another of the plurality of driving terminals of the motor.

12. The motor driver according to claim 11, wherein the plurality of high-side switches further includes a third high-side switch, and the plurality of low-side switches further includes a third low-side switch;
wherein a first terminal of the third high-side switch is coupled to the common voltage, a second terminal of the third high-side switch is connected to a first terminal of the third high-side switch, a second terminal of the third high-side switch is grounded, and a node between the second terminal of the third high-side switch and the first terminal of the third high-side switch is connected to yet another of the plurality of driving terminals of the motor.

13. The motor driver according to claim 12, wherein the motor is a three-phase motor.

14. A motor driver having an overcurrent protection mechanism, comprising:
an output stage circuit including:
a plurality of high-side switches each having a first terminal, a second terminal and a control terminal, wherein the first terminal of each of the plurality of high-side switches is coupled to a common voltage; and
a plurality of low-side switches each having a first terminal, a second terminal and a control terminal, wherein the first terminals of the plurality of low-side switches are respectively connected to the second terminals of the plurality of high-side switches and respectively connected to a plurality of driving terminals of a motor; and
a motor driving circuit connected to the control terminal of each of the plurality of high-side switches, and connected to the control terminal and the second terminal of each of the plurality of low-side switches;
wherein the motor driving circuit is configured to sense a voltage of the second terminal of each of the plurality of low-side switches, as a first sensed voltage;
wherein, when the first sensed voltage is higher than a reference voltage, the motor driving circuit turns off the plurality of high-side switches and times a time during which the plurality of high-side switches are turned off as an off-time;
wherein, when the off-time reaches a preset protection time, the motor driving circuit senses the second terminal of each of the plurality of low-side switches as a second sensed voltage;
wherein, when the second sensed voltage is higher than the reference voltage, the motor driving circuit turns off the plurality of low-side switches and continually turns off the plurality of high-side switches.
